(19) United States
(12) Patent Application Publication
(10) Pub. No.: US 2025/0277388 A1
(43) Pub. Date: Sep. 4, 2025

(54) WOOD UTILITY POLE PROTECTIVE COVER

(71) Applicant: DelStar Technologies, Inc., Alpharetta, GA (US)

(72) Inventors: Bruce Choi, St. Paul, MN (US); Chris Hakanson, St. Paul, MN (US)

(21) Appl. No.: 19/066,835

(22) Filed: Feb. 28, 2025

Related U.S. Application Data
(60) Provisional application No. 63/560,435, filed on Mar. 1, 2024.

(51) Int. Cl. E04H 12/22; A01M 29/12; D04H 1/4291

(52) U.S. Cl. CPC E04H 12/2292; A01M 29/12; D04H 1/4291; D10B 2401/12; D10B 2505/18

(57) ABSTRACT

A cover such as a sleeve or wrap that can work alone, or in combination with existing preservation processes, to improve the condition of utility wood poles is provided. The sleeve or wrap can improve protection as well as structurally bolster the wood poles in the field. The sleeve or wrap can also act to upgrade wood poles of a lower grade or quality to a higher grade or quality that would qualify it for use in the field, thereby increasing overall supply of wood poles available for grids.

### CROSS-REFERENCE TO RELATED APPLICATIONS

This application claims the benefit of U.S. Provisional Application No. 63/560,435 filed Mar. 1, 2024, the complete disclosure of which is incorporated herein by reference in its entirety for all purposes.

### TECHNICAL FIELD

A cover for wood poles is provided. The cover may comprise a sleeve or wrap that is configured to protect and/or support wood utility poles of the type used in electric or power grids, and can be used for wood utility pole preservation, restoration, reinforcement, repair, or to otherwise improve its condition.

### BACKGROUND

Electricity is vital to the proper functioning of modern societies. Many rely on electricity not just for basic living necessities like heating, lighting and cooking, but increasingly more of us need electricity to charge and run our electric vehicles. In North America, as well as in many other developed countries, electricity is obtained from the electric grid, an interconnected network of power lines and other infrastructure that allows us to move electricity from power plants to our homes, businesses and factories. The backbone of this distribution network of electrical delivery, also known as the “power grid” or simply the “grid”, are wood poles. Unlike their wood-like counterparts such as steel, concrete and fiberglass, wood is a renewable resource that has been proven to have the necessary strength, resiliency, and service life for these power grids.

These wood poles are subject to harsh environmental conditions from the moment they are installed in the field. For example, wood poles are subject to weather damage, such as from strong winds, heavy rain, and scorching heat from the sun. The wind can cause wood poles to bend and deform, while heavy rains can soak the wood poles with water that can result in water damage ranging from mildew to rot. High heat from the sun can cause wood poles to burn, and even catch fire. Even in the most temperate of weather conditions, wood poles are susceptible to unwanted insect infestation, and damage from birds such as woodpeckers. Oftentimes the wood utility poles are placed along busy streets, with the poles being installed relatively close to the road where they are exposed to blunt force trauma from vehicles crashing into them.

Currently, wood poles undergo preservation processing to treat the wood before they are sent to be installed in the field. However, not all types or grades of wood are eligible to make it to the processing stage. Only certain types and/or grades of wood are selected for use, leaving the relatively less expensive types or grades of wood ineligible. When a wood pole is damaged beyond repair, the solution is to replace the wood pole with a new one. This substitution process is time-consuming and expensive due to the labor involved, and leaves that portion of the electric grid inoperable during the replacement. Accordingly, improved solutions that are easy to implement and are cost-effective, and that can extend the service life of the wood poles are always desired and are continuously sought.

### SUMMARY

A cover such as a sleeve or wrap that can work alone, or in combination with existing preservation processes, to improve the condition of wood utility poles is provided. The sleeve or wrap can improve protection as well as structurally bolster the wood poles in the field. The sleeve or wrap can also act to upgrade wood poles of a lower grade or quality to a higher grade or quality that would qualify it for use in the field, thereby increasing overall supply of wood poles available for grids.

In accordance with an aspect of the disclosure, a surface cover for a wood pole is provided. The surface cover may comprise a main body having a net structure formed of a plurality of intersecting strands and shaped openings between the intersecting strands, the main body being formed from a thermoplastic material. In one embodiment, the main body may have a cylindrical shape with a first, open end and a second, open end, the main body being configured to slip over the wood pole. In another embodiment, the main body may be configured to wrap around a length of the wood pole.

According to an aspect of the surface cover, the shaped openings of the net structure may comprise diamond shaped openings.

According to an aspect of the surface cover, the thermoplastic may comprise a polyolefin. The polyolefin may comprise a polypropylene, polylactic acid, polyethylene, a polybutylene adipate terephthalate, or a blend thereof.

According to an aspect of the surface cover, the net structure may comprise a monofilament and extruded, non-woven material.

According to an aspect of the surface cover, the thermoplastic material may be partially or fully biodegradable.

According to an aspect of the surface cover, the net structure may have a thickness in the range of about 0.050 to about 0.300 inches.

According to an aspect of the surface cover, the net structure may have a knot count in the range of about 1 to about 50 in the transverse direction.

According to an aspect of the surface cover, the net structure may have a basis weight in the range of about 100-300 lbs. per 1,000 ft².

According to an aspect of the surface cover, the net structure may have strands per inch in the range of about 0.1 to about 5 in the transverse direction (TD), and about 0.1 to about 5 in the machine direction (MD).

According to an aspect of the surface cover, the diamond shaped openings may have a length in the range of about 10 to 25 mm and a width in the range of about 10 to 25 mm.

According to an aspect of the surface cover, the main body may include an additive for protecting the wood pole against environmental conditions. The additive may be incorporated into the thermoplastic material, or within a layer adjacent the net structure, or within a coating over the strands of the net structure.

In one embodiment, the additive may be an insect repellent, a bird repellant, an antifungal agent, or a fire retardant agent. The bird repellant may be configured to repel woodpeckers. An additive that acts as a bird repellant can include methylanthranilate (MA), a water-based bird repellant derived from grapes that has a bitter taste and a smell that birds avoid, as a non-limiting example.

In another embodiment, the additive may be a fungicidal agent. An additive that can act as a fungicidal agent can include benzimidazoles, dithiocarbamates, strobilurins, and azoles such as triazoles, as non-limiting examples.

In still another embodiment, the additive may be a fire retardant agent. An additive that can act as a fire retardant agent can include boron compounds, antimony oxides, huntite, hydromagnesite, zinc oxides, organohalogen compounds such as brominated flame retardant plastic additives (BRFs), halogenated chlorine and bromine, and inorganic hydroxides such as aluminum hydroxide, as non-limiting examples.

In yet another embodiment, the additive may be a color agent, a luminescent agent, a fluorescent agent, a photoluminescent agent, or a light reflective agent. This improves visibility of the wood pole to drivers, bicycle riders, utility repairmen and others in the vicinity in either daylight or at night.

In even still another embodiment, the surface cover may include an adhesive. The adhesive layer may improve adherence of the sleeve to the pole over time. The adhesive may comprise any one or more of elastomers, thermoplastics, emulsions or thermosets, such as thermoset adhesives like epoxy, polyurethane, cyanoacrylate and acrylic polymers. In some embodiments, the adhesive may be laminated to the net and include a liner that is removed prior to application to the wood pole, but otherwise helps with handling of the sleeve. The liner may be a polyester film, a polyolefin film, siliconized paper, or a plastic laminated paper, as non-limiting examples. An additional benefit of having an optional adhesive layer is that the adhesive layer can act as a reinforcing tape and strengthen the sleeve.

According to an aspect of the surface cover, the wood pole may be a wood utility pole, and may be configured for an electrical or telephone grid.

In accordance with another aspect of the disclosure, a utility grid is provided. The utility grid may comprise a network of connected wood poles, and at least one surface cover for at least one of the connected wood poles, wherein the at least one surface cover comprises a main body having a net structure formed of a plurality of intersecting strands and shaped openings between the intersecting strands, the main body being formed from a thermoplastic material. According to an aspect of the utility grid, the grid can be an electrical or telephone grid.

In accordance with yet another aspect of the disclosure, a method for protecting or bolstering a wood pole is provided. The method comprises selecting a wood pole for processing, providing a surface cover for the wood pole, and placing the surface cover over a length of the wood pole that is exposed to environmental conditions, wherein the surface cover comprises a main body having a net structure formed of a plurality of intersecting strands and shaped openings between the intersecting strands, the main body being formed from a thermoplastic material.

According to an aspect of the method, the main body has a cylindrical shape with a first, open end and a second, open end, and the step of placing the surface cover over a length of the wood pole comprises sliding the main body over the wood pole.

According to an aspect of the method, the step of placing the surface cover over a length of the wood pole comprises wrapping the main body around the length of the wood pole. The wood pole may be wrapped before being installed in a utility grid, or the wood pole may be one already installed in a utility grid.

According to an aspect of the method, the surface cover is placed over the wood pole prior to a preservation treatment of the wood pole.

According to an aspect of the method, the surface cover is placed over the wood pole after a preservation treatment of the wood pole.

According to an aspect of the method, a preservation treatment may be applied to the surface cover and the wood pole.

It is to be understood that both the foregoing general description and the following detailed description are exemplary and explanatory only and are not restrictive of the disclosure. Additional features of the disclosure will be set forth in part in the description which follows or may be learned by practice of the disclosure.

### BRIEF DESCRIPTION OF THE DRAWINGS

The accompanying drawings, which are incorporated in and constitute a part of this specification, illustrate several embodiments of the disclosure and together with the description, serve to explain the principles of the disclosure.

FIG. 1A illustrates a perspective view of an exemplary embodiment of an external protective cover of the present disclosure in the form of a sleeve.

FIG. 1B illustrates a cross-sectional side view of the sleeve of FIG. 1A.

FIG. 1C illustrates a top-down view of the sleeve of FIG. 1A.

FIG. 1D illustrates an enlarged view of the sleeve of FIG. 1C.

FIG. 2A illustrates a cross-sectional side view of an exemplary embodiment of a sleeve with optional layers of additives.

FIG. 2B illustrates a cross-sectional side view of another exemplary embodiment of a sleeve with an optional adhesive layer.

FIG. 3 illustrates a perspective view of the sleeve of FIG. 1A around a wooden utility pole.

FIG. 4 illustrates a perspective view of another exemplary embodiment of an external protective cover of the present disclosure in the form of a wrap being applied to a wooden utility pole.

FIG. 5 illustrates the external protective sleeves of FIG. 1A in use with wood utility poles of a power grid.

### DETAILED DESCRIPTION OF THE EMBODIMENTS

This description and the accompanying drawings illustrate exemplary embodiments and should not be taken as limiting, with the claims defining the scope of the present disclosure, including equivalents. Various mechanical, compositional, structural, and operational changes may be made without departing from the scope of this description and the claims, including equivalents. In some instances, well-known structures and techniques have not been shown or described in detail so as not to obscure the disclosure. Like numbers in two or more figures represent the same or similar elements. Furthermore, elements and their associated aspects that are described in detail with reference to one embodiment may, whenever practical, be included in other embodiments in which they are not specifically shown or described. For example, if an element is described in detail with reference to one embodiment and is not described with reference to a second embodiment, the element may nevertheless be claimed as included in the second embodiment. Moreover, the depictions herein are for illustrative purposes only and do not necessarily reflect the actual shape, size, or dimensions of the system or illustrated components.

It is noted that, as used in this specification and the appended claims, the singular forms “a,” “an,” and “the,” and any singular use of any word, include plural referents unless expressly and unequivocally limited to one referent. As used herein, the term “include” and its grammatical variants are intended to be non-limiting, such that recitation of items in a list is not to the exclusion of other like items that can be substituted or added to the listed items.

Except as otherwise noted, any quantitative values are approximate whether the word “about” or “approximately” or the like are stated or not. The materials, methods, and examples described herein are illustrative only and not intended to be limiting.

As used throughout, ranges are used as shorthand for describing each and every value that is within the range. It should be appreciated and understood that the description in a range format is merely for convenience and brevity and should not be construed as an inflexible limitation on the scope of any embodiments or implementations discussed herein. Accordingly, the range should be construed to have specifically included all the possible subranges as well as individual numerical values within that range. As such, any value within the range may be selected as the terminus of the range. For example, description of a range such as from 1 to 5 should be considered to have specifically included subranges such as from 1.5 to 3, from 1 to 4.5, from 2 to 5, from 3.1 to 5, etc., as well as individual numbers within that range, for example, 1, 2, 3, 3.2, 4, 5, etc. This applies regardless of the breadth of the range.

Additionally, all numerical values are “about” or “approximately” the indicated value, and take into account experimental error and variations that would be expected by a person having ordinary skill in the art. It should be appreciated that all numerical values and ranges discussed herein are approximate values and ranges, whether “about” is used in conjunction therewith. It should also be appreciated that the term “about,” as used herein, in conjunction with a numeral refers to a value that may be ±0.01% (inclusive), ±0.1% (inclusive), ±0.5% (inclusive), ±1% (inclusive) of that numeral, ±2% (inclusive) of that numeral, ±3% (inclusive) of that numeral, ±5% (inclusive) of that numeral, ±10% (inclusive) of that numeral, or ±15% (inclusive) of that numeral. It should further be appreciated that when a numerical range is discussed herein, any numerical value falling within the range is also specifically included.

For purposes of illustration, the embodiments are described with reference to applications for wood utility poles, such as for example wood utility poles that are used in electric or power grids, or for telephone wires. However, the embodiments may be implemented in any application involving wood poles that are used outdoors and are subject to wear and tear from the environment, whether for carrying electricity, or for mechanical stabilization of structures like balconies, decks, bridges, piers, fences, gates, etc.

In general, the external protective cover relates to a component for placement over a wood pole to be installed outdoors and is subject to environmental conditions such as those mentioned above. As previously discussed, the cover can comprise a sleeve or wrap that can work alone, or in combination with existing preservation processes, to improve the condition of the wood poles. The sleeve or wrap can improve protection as well as structurally bolster the wood poles in the field. The sleeve or wrap can also act to upgrade wood poles of a lower grade or quality to a higher grade or quality that would qualify it for use in the field, thereby increasing overall supply of wood poles available for power grids or for other uses of wood poles, as mentioned above.

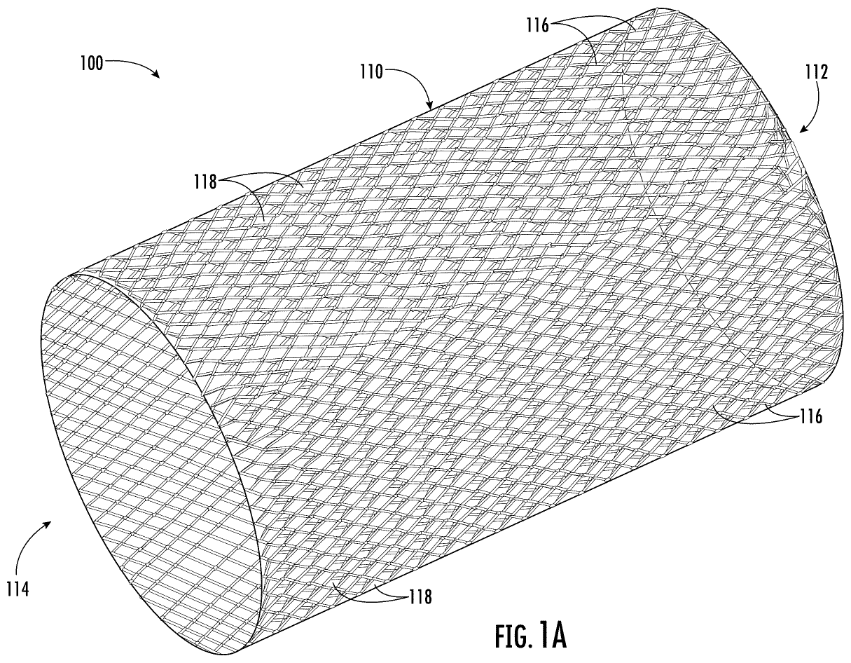

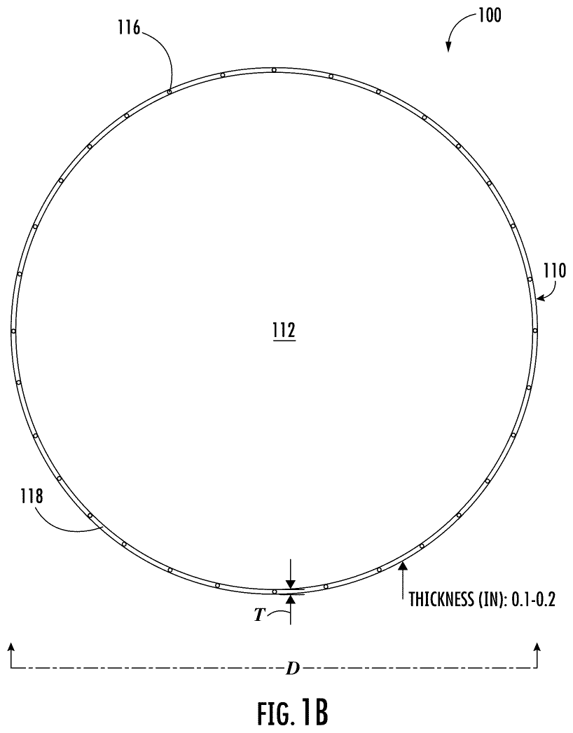

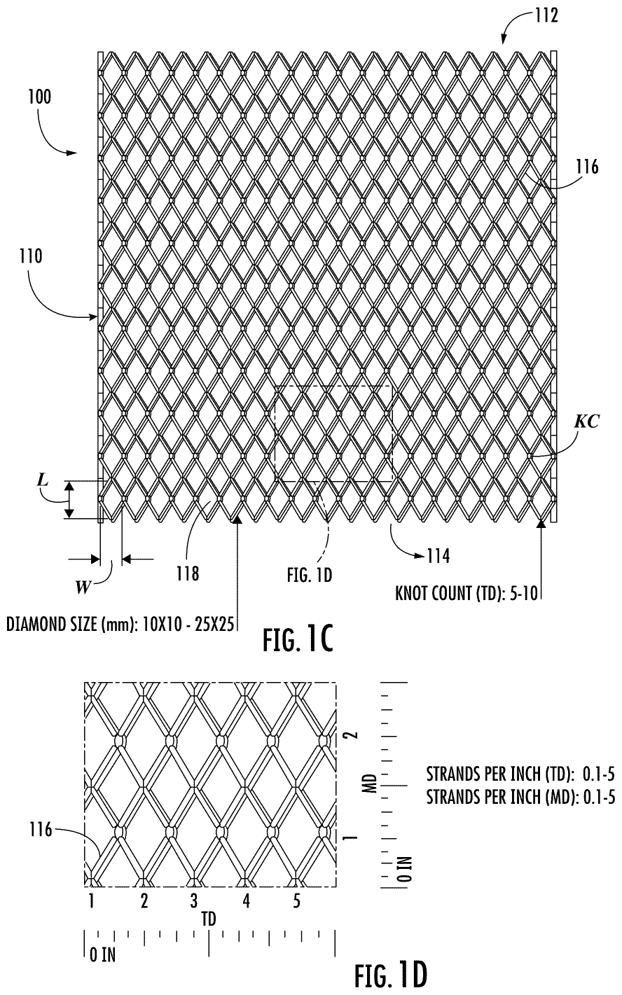

Turning now to FIG. 1A, an exemplary embodiment of a cover in the form of an external protective sleeve 100 for wood utility poles is shown. The protective sleeve 100 may include a main body 110, a first open end 112, and a second open end 114. The main body 110 may be formed from a net comprising a plurality of strands 116 that connect at discrete points or knots (KC) along their length to form diamond shaped openings 118, as shown. As illustrated, the main body or net 110 may have a pre-formed cylindrical shape that allows the external protective sleeve 100 to slip over the wood pole, as will be described in more detail below.

In some embodiments, the net 110 may have a thickness in the range of about 0.050 to about 0.300 inches. As shown in FIG. 1B, in one exemplary embodiment, the net 110 may have a thickness T in the range of about 0.1 to about 0.2 inches, for example. In one exemplary embodiment, the basis weight may be in the range of about 100-300 lbs. per 1,000 ft². The diameter D of the net may be in the range of about 10-36 inches to accommodate most electric grid poles or telephone poles.

In some embodiments, the net 110 may have a knot count KC in the range of about 1 to about 50 in the cross, or transverse, direction (TD), over a 10 inch span. For example, as shown in FIG. 1C, in one exemplary embodiment, the net 110 may have a knot count in the range of about 5 to about 10 in the transverse direction. As further shown in the enlarged view of FIG. 1D, the strands per inch may range from about 0.1 to about 5 in the transverse direction (TD), and about 0.1 to about 5 in the machine direction (MD).

In some embodiments, the net 110 may comprise a plurality of diamond-shaped openings 118. The diamond-shaped openings 118 may have a size in the range of about 5×254 mm. In some embodiments, the diamond shaped openings 118 can have a length in the range of about 10 to 25 mm and a width in the range of about 10 to 25 mm. For example, as shown in FIG. 1C, in one exemplary embodiment, the diamond-shaped opening may have a length L of about 25 mm and a width W of about 25 mm. Of course, it is understood that the openings 118 are not limited to a diamond shape, and could easily work with other shapes, including but not limited to, squares, rhombuses, hexagons, as well as ovals and circles.

This net 110 may comprise an industrial-grade thermoplastic material such as a polyolefin. Exemplary polyolefins can include a polypropylene (PP) or another suitable anti-oxidant grade polymer or resin, including but not limited to polylactic acid (PLA), polyethylene (PE), or polybutylene adipate terephthalate (PBAT). In one exemplary embodiment, the net may be formed from a monofilament and extruded, non-woven material. In some embodiments, the material may be a biodegradable material. Of course, the external protective sleeve 100 may be provided for either multiple uses or single/disposable use.

As mentioned, the sleeve 100 may provide additional protection from the environmental conditions that the wood poles are subject to in the field. The protection can be provided as an additive that is incorporated into the material forming the net 110 itself. In this manner, the net 110 may be formed of a composite material that includes the thermoplastic polymer and one or more additives. The additive or additives may be incorporated by being mixed into the polymer material. For example, in some cases, the additive may be embedded or impregnated into the polymer. In other cases, the additive or additives may be sprayed onto, or coated over, the polymeric net 110. In still other cases, the additive or additives may be provided as a separate, added layer to the net 110. One or more layers may be applied onto the thermoplastic net 110.

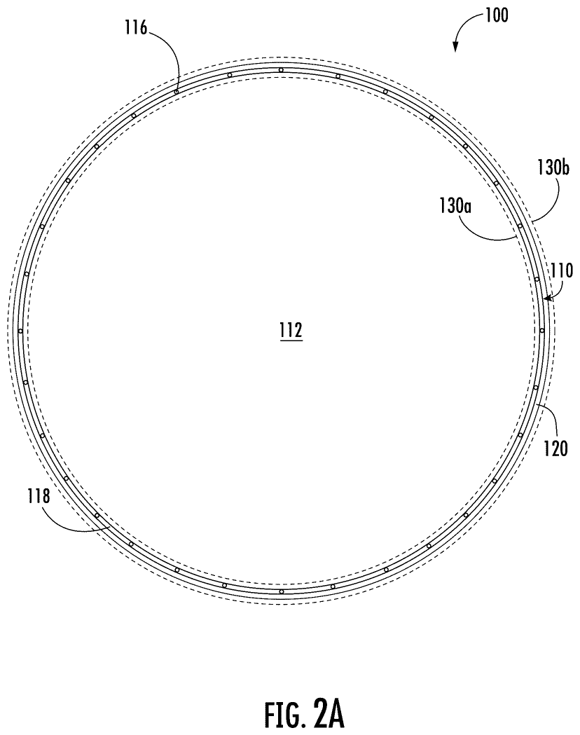

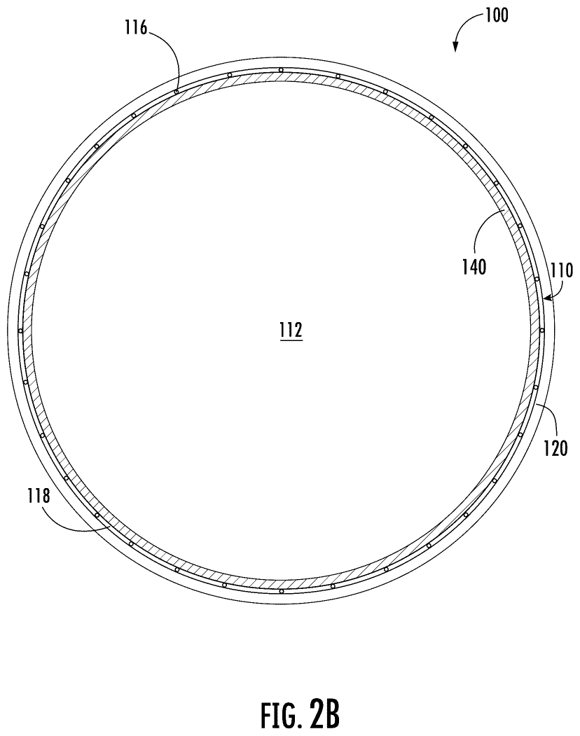

Various embodiments of these configurations are shown in FIGS. 2A and 2B. A first layer of additive material 120 may be placed over the thermoplastic net 110. A second, further layer of additive material 130a may optionally be placed under the thermoplastic net 110. In another embodiment, the second layer of additive material 130b may optionally be placed over the first layer of additive material 120, as shown in FIG. 2A. In some embodiments, both layers 130a and 130b may be utilized at the same time as a second and third layer, respectively. The arrangement of the layers 120, 130a, 130b may vary from the illustration without departing from the spirit of the invention. For example, the layers 120, 130a, 130b may be placed over the thermoplastic net 110, or they may be placed under the thermoplastic net 110. The layers may be arranged such that the thermoplastic net 110 may reside anywhere between the layers 120, 130a, 130b. It should be understood that the layer 120, 130a, 130b may be a solid, continuous layer, or the layer 120, 130a, 130b may be discontinuous (i.e., applied in a discrete section or sections along the length of the net 110), and/or have openings similar to net 110. Also, the layers 120, 130a, 130b may be the same (i.e., there is more than one of the same layer of additive material) or different.

In one exemplary embodiment, the sleeve 100 may include an additive that acts as an insect repellent or a bird repellant, such as a woodpecker repellant. One such additive that can be utilize here is methylanthranilate (MA), a water-based bird repellant derived from grapes that has a bitter taste and a smell that birds avoid, as a non-limiting example.

In another exemplary embodiment, the additive may be an antifungal agent to reduce wood-destroying fungi from growing on the wood pole. Exemplary fungicidal agents that can be utilized here include benzimidazoles, dithiocarbamates, strobilurins, and azoles such as triazoles, as non-limiting examples.

In still another exemplary embodiment, the additive may be a fire retardant agent. Exemplary fire retardant additives that can be utilized here include boron compounds, antimony oxides, huntite, hydromagnesite, zinc oxides, organohalogen compounds such as brominated flame retardant plastic additives (BRFs), halogenated chlorine and bromine, and inorganic hydroxides such as aluminum hydroxide, as non-limiting examples.

In yet another embodiment, the additive may be a color agent, a luminescent/fluorescent agent such as a photoluminescent agent, or a light reflective agent. The agent improves visibility of the wood pole to drivers, bicycle riders, utility repairmen and others in the vicinity in either daylight or at night. For example, a photoluminescent pigment may be incorporated into the thermoplastic material to enable the sleeve 100 to glow in the dark and improve visibility of the poles to drivers, bicycle riders or utility repairmen at night. In other instances, a color dye may be used to provide the sleeve 100 with a unique color that is in contrast to its surroundings to improve its visibility during the day.

In some embodiments, the color or light reflective agent may be uniformly present on the sleeve 100. In this case, the entire sleeve has a uniform color or the effect of the light reflection occurs along the entire length of the sleeve 100. In other embodiments, the color or light reflective agent may be concentrated or isolated to a specific section or sections of the sleeve 100, such as for example, at the top of the sleeve 100. In this case, the color or light reflection appears as a single band, or a series of bands, along the length of the sleeve 100.

As previously discussed, the additive may be incorporated into the thermoplastic material in the formation of the net body 110 of the external sleeve 100, or the additive may be added to the net body 110 as a layer, or by coating or by applying the additive to the diamond-shaped openings 118 of the net body 110.

The sleeve 100 may optionally include an adhesive layer 140, as shown in FIG. 2B. The adhesive layer 140 may improve adherence of the sleeve 100 to the pole over time. The adhesive may comprise any one or more of elastomers, thermoplastics, emulsions or thermosets, such as thermoset adhesives like epoxy, polyurethane, cyanoacrylate and acrylic polymers. In some embodiments, the adhesive may be laminated to the net 110 and include a liner (not shown) that is removed prior to application to the wood pole, but otherwise helps with handling of the sleeve 100. The liner may be a polyester film, a polyolefin film, siliconized paper, or a plastic laminated paper, as non-limiting examples. An additional benefit of having an optional adhesive layer 140 is that the adhesive layer 140 can act as a reinforcing tape and strengthen the sleeve 100. Further, although shown in FIG. 2B as being adjacent the net 110, it is contemplated that the optional adhesive layer 140 may also be applied over the layer of additive 120, 130a, 130b.

In addition to offering protection from the environment, the sleeve 100 may also offer additional structural support as a kind of bolster to the wood pole. As mentioned, the use of the sleeve 100 may allow an upgrade of the pole class of the wood pole.

Below is an ANSI chart showing the characterization of pole classes:

| | Base Diameter | Top Diameter |
|---|---|---|
| Pole Class | (inches) | (inches) |
| Class 1 | 27 | 14 |
| Class 2 | 24 | 12 |
| Class 3 | 21 | 10 |
| Class 4 | 18 | 8 |
| Class 5 | 15 | 6 |

Class 2 poles (thicker wood) are in high demand but weaker class 4 poles (thinner wood) are more ubiquitous in nature and are typically used for utility pole installation. It is contemplated that the external sleeve 100 could improve class 4 wood poles to a higher grade classification, such as elevating the pole classification to a class 2 or 3, by increasing the diameter of the pole. This would allow the strengthening of the more abundantly available wood to meet the greater load demand found in more scarce, thicker wood.

Additionally, it is contemplated that the net structure of the sleeve 100 can create a torsional counteracting force when strong wind gusts exert pressure on the pole and cause the wood pole to bend, thereby serving as a general structural support to the wood pole to avoid wind damage (such as bending, cracking, uprooting of the wood pole, etc.) As the net twists with the pole movement in strong winds or from blunt force impact from accidents, the diamond shaped openings 118 can deform or close up, causing the strands 116 to come closer together, tightening the sleeve 100 around the diameter of the wood pole and act as a more solid wind barrier and/or contain the failure mode to lessen the severity of blunt force impact of vehicular accidents.

In addition to allowing additive agents to be carried in the openings 118, the net structure of the sleeve 100 also provides the further benefit of allowing pole repairmen to use their existing foot spikes on their work boots to penetrate through the openings 118 of the net 110 and climb and treat the pole.

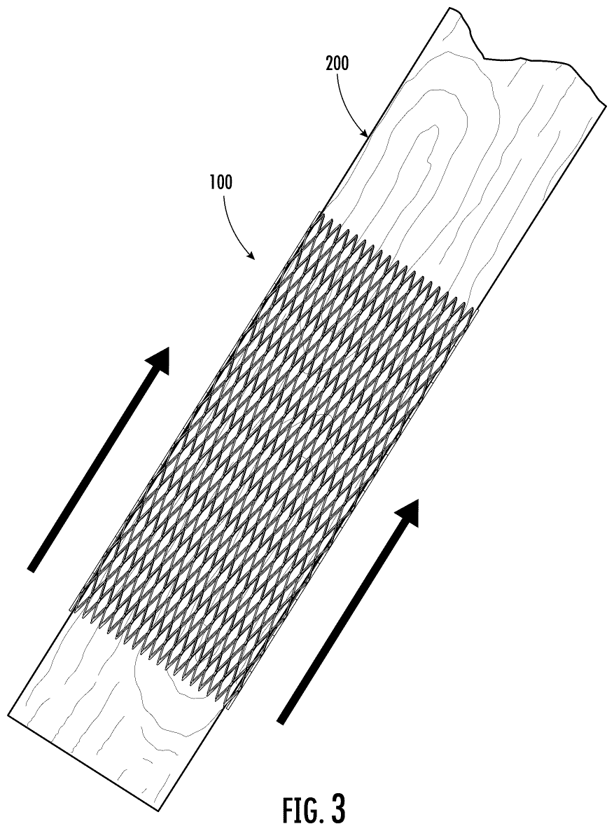

FIG. 3 illustrates an exemplary method of applying the external protective sleeve 100. The sleeve 100 may have a diameter D ranging from about 10 to 36 inches, and a length ranging from about 20 to about 150 feet. The sleeve 100 may be configured to slip over a wood pole 200, as shown, with a length that can cover anywhere from about 50 to 99% of the exposed length of the pole 200 after installation. Although not shown, it should be understood that the sleeve 100 can include optional layers 120, 130a, 130b with additives and/or adhesive layer 140 with liner as previously described.

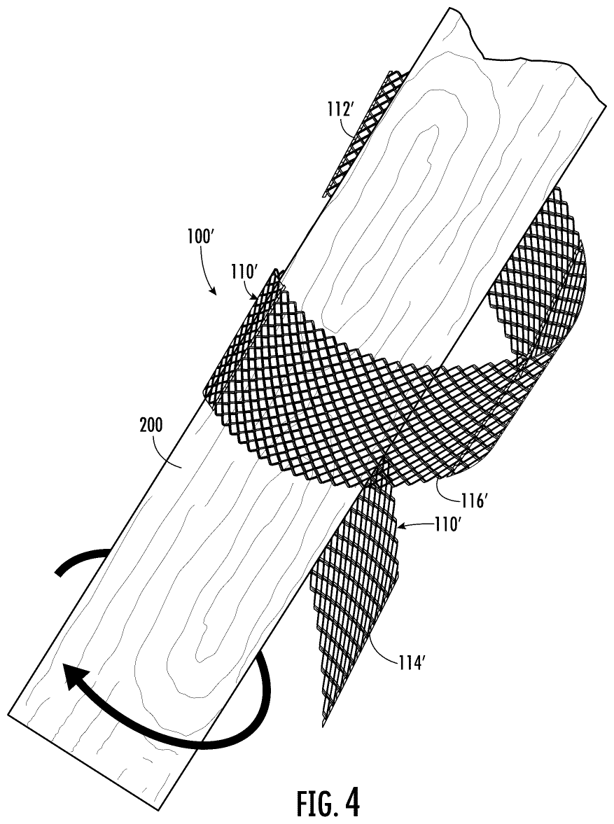

FIG. 4 illustrates an exemplary embodiment of a cover in the form of an external wrap 100′ having the same net body 110′ as sleeve 100, but in a roll configuration to enable wrapping, such as spiral wrapping, around a pole. As shown, the external wrap 100′ has the same net configuration as external sleeve 100, with strands 116′ that form diamond-shaped openings 118′. The first end 112′ of the wrap 100′ can be applied around the diameter of the wood pole 200 until the desired length of the overall wrap 100′ is achieved. With each turn or rotation, the net body 110′ can overlap onto itself, or it can be placed side-by-side to form a smooth, even outer casing. The wrap 100′ may be applied to already existing wood poles in the field, to protect and/or structurally support already installed wood poles of utility grids and thereby extend their service life. Although not shown, it should be understood that the net body 110′ can include optional layers 120, 130a, 130b with additives and/or adhesive layer 140 with liner as previously described.

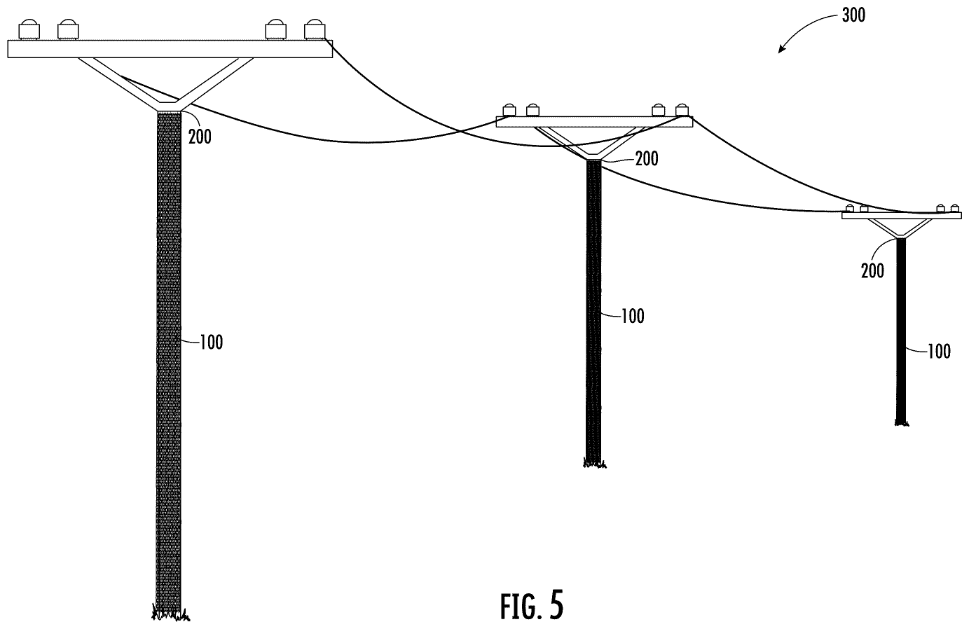

FIG. 5 illustrates a utility grid 300 such as an electric or telephone grid comprising a network of wood utility poles 200 having the external sleeves 100 applied thereon.

It is understood that the external sleeve 100 and external wrap 100′ can be incorporated into the existing process of preparing wood poles for utility grids, without significant disruption or added cost and time. Some exemplary ways in which the external sleeve 100 or external wrap 100′ can be included in the process are described below.

In a typical process for preparing the wood poles, the trees or lumber are first identified and cut down. The most common type of poles are made from Southern Yellow Pine, though of course any comparable wood can be selected. Trees of about 35-40 years of age are generally selected. Once cut or harvested, the trees go to the processing stage.

In the processing stage, the cut trees are debarked and machined or cut to a desired length. The debarked and cut wood is then measured to determine its diameter and its proper size class (as explained above, the pole's class is based in part on its diameter). The pole's class determines its load capacity. After classification, the poles are dried and then sterilized to kill any decay spores.

After about 1 to 3 days of drying, the poles are spread out on skids for framing and inspection. Preservative and preservative retention treatments are also applied. The step of framing involves cleaning any bark left over from the pole from peeling, putting required gains on the poles, boring any necessary holes, and applying burn brands or insect metal tags to the face of the pole. These metal tags provide information such as:
a) producer
b) date of treatment
c) preservative
d) required preservative retention
e) length
f) class

Next, the poles are inspected by the pole producer and any outside inspector requested by the customer. The poles are sent to a sealing container where they are loaded inside for a pressure vacuum treating cycle. Upon completion of the cycle, sample borings of the poles are taken and analyzed to check that retention requirements and desired treatment penetration have been achieved. If the poles meet all physical and treatment requirements, then the poles can be delivered to the utility company (or customer) to be installed.

In an exemplary method, the external sleeve 100 or wrap 100′ may be applied over the wood pole after the preservative and preservative retention treatments are applied at the framing stage.

In another exemplary method, the external sleeve 100 or wrap 100′ may be applied over the wood pole after the drying stage before framing, with the sleeve 100 or wrap 100′ including preservative and preservative retention additives that replace the treatment step during framing. Eliminating the preservative and preservation retention treatment step would greatly reduce the burden of product application during the pole manufacturing process.

In still another exemplary method, the external sleeve 100 or wrap 100′ may be applied to the wood pole after drying and before the preservative and preservative retention treatments, whereupon the preservative and preservative retention treatments are applied to the wood pole with the external sleeve 100 or wrap 100′ already in place.

By preservative and preservative retention additives, what is meant is an additive that acts as an insect repellent or a bird repellant, such as a woodpecker repellant, an antifungal agent to reduce wood-destroying fungi from growing on the wood pole, or a fire retardant agent.

Exemplary agents have been described above. For example, an additive that acts as a bird repellant can include methylanthranilate (MA), a water-based bird repellant derived from grapes that has a bitter taste and a smell that birds avoid, as a non-limiting example. An additive that can act as a fungicidal agent can include benzimidazoles, dithiocarbamates, strobilurins, and azoles such as triazoles, as non-limiting examples. An additive that can act as a fire retardant agent can include boron compounds, antimony oxides, huntite, hydromagnesite, zinc oxides, organohalogen compounds such as brominated flame retardant plastic additives (BRFs), halogenated chlorine and bromine, and inorganic hydroxides such as aluminum hydroxide, as non-limiting examples.

Furthermore, the wrap 100′ may include the optional layers 120, 130a, 130b and adhesive layer 140, including liner, as described above with respect to sleeve 100. The configuration of the layers and adhesive with respect to sleeve 100 also apply to wrap 100′ as well.

By utility pole, what is meant is a utility pole for an electric grid, a telephone grid, or a comparable utility feature.

Other embodiments will be apparent to those skilled in the art from consideration of the specification and practice of the embodiment disclosed herein. It is intended that the specification and examples be considered as exemplary only, with a true scope and spirit of the embodiment being indicated by the following claims.

For example, according to a first aspect, in a 1^{st} embodiment, a surface cover for a wood pole is provided. The surface cover comprises a main body having a net structure formed of a plurality of intersecting strands and shaped openings between the intersecting strands, the main body being formed from a thermoplastic material.

A 2^{nd} embodiment is the 1^{st} embodiment of the surface cover, wherein the main body has a cylindrical shape with a first, open end and a second, open end, the main body being configured to slip over the wood pole.

A 3^{rd} embodiment is any combination of the first 2 embodiments, wherein the main body may is configured to wrap around a length of the wood pole.

A 4^{th} embodiment is any combination of the first 3 embodiments, wherein the shaped openings comprise diamond shaped openings.

A 5^{th} embodiment is any combination of the first 4 embodiments, wherein the thermoplastic comprises a polyolefin.

A 6^{th} embodiment is any combination of the first 5 embodiments, wherein the polyolefin comprises a polypropylene, polylactic acid, polyethylene, a polybutylene adipate terephthalate, or a blend thereof.

A 7^{th} embodiment is any combination of the first 6 embodiments, wherein the net structure comprises a monofilament and extruded, non-woven material.

An 8^{th} embodiment is any combination of the first 7 embodiments, wherein the thermoplastic material is partially or fully biodegradable.

A 9^{th} embodiment is any combination of the first 8 embodiments, wherein the net structure has a thickness in the range of about 0.050 to about 0.300 inches.

A 10^{th} embodiment is any combination of the first 9 embodiments, wherein the net structure has a knot count in the range of about 1 to about 50 in the transverse direction.

An 11^{th} embodiment is any combination of the first 10 embodiments, wherein the main body has a basis weight in the range of about 100-300 lbs. per 1,000 ft².

A 12^{th} embodiment is any combination of the first 11 embodiments, wherein the strands per inch of the net structure is in the range of about 0.1 to about 5 in the transverse direction (TD), and about 0.1 to about 5 in the machine direction (MD).

A 13^{th} embodiment is any combination of the first 12 embodiments, wherein the diamond shaped openings have a length in the range of about 10 to 25 mm and a width in the range of about 10 to 25 mm.

A 14^{th} embodiment is any combination of the first 13 embodiments, wherein the main body includes an additive for protecting the wood pole against environmental conditions.

A 15^{th} embodiment is any combination of the first 14 embodiments, wherein the additive is incorporated into the thermoplastic material, or within a layer adjacent the net structure, or within a coating over the strands of the net structure.

A 16^{th} embodiment is any combination of the first 15 embodiments, wherein the additive is an insect repellent, a bird repellant, an antifungal agent, or a fire retardant agent.

A 17^{th} embodiment is any combination of the first 16 embodiments, wherein the bird repellant is configured to repel woodpeckers.

An 18^{th} embodiment is any combination of the first 17 embodiments, wherein the additive is a color agent, a luminescent agent, a fluorescent agent, a photoluminescent agent, or a light reflective agent.

A 19^{th} embodiment is any combination of the first 18 embodiments, further including an adhesive layer.

A 20^{th} embodiment is any combination of the first 19 embodiments, wherein the wood pole is a wood utility pole.

A 21^{st} embodiment is any combination of the first 20 embodiments, wherein the utility pole is configured for an electrical or telephone grid.

According to a second aspect, in a 1^{st} embodiment, a utility grid is provided. The utility grid comprises a network of connected wood poles, and at least one surface cover for at least one of the connected wood poles. The at least one surface cover comprises a main body having a net structure formed of a plurality of intersecting strands and shaped openings between the intersecting strands, the main body being formed from a thermoplastic material.

A 2^{nd} embodiment is the 1^{st} embodiment of the utility grid, wherein the main body has a cylindrical shape with a first, open end and a second, open end, the main body being configured to slip over the wood pole.

A 3^{rd} embodiment is any combination of the first 2 embodiments, wherein the main body may is configured to wrap around a length of the wood pole.

A 4^{th} embodiment is any combination of the first 3 embodiments, wherein the shaped openings comprise diamond shaped openings.

A 5^{th} embodiment is any combination of the first 4 embodiments, wherein the thermoplastic comprises a polyolefin.

A 6^{th} embodiment is any combination of the first 5 embodiments, wherein the polyolefin comprises a polypropylene, polylactic acid, polyethylene, a polybutylene adipate terephthalate, or a blend thereof.

A 7^{th} embodiment is any combination of the first 6 embodiments, wherein the net structure comprises a monofilament and extruded, non-woven material.

An 8^{th} embodiment is any combination of the first 7 embodiments, wherein the thermoplastic material is partially or fully biodegradable.

A 9^{th} embodiment is any combination of the first 8 embodiments, wherein the net structure has a thickness in the range of about 0.050 to about 0.300 inches.

A 10^{th} embodiment is any combination of the first 9 embodiments, wherein the net structure has a knot count in the range of about 1 to about 50 in the transverse direction.

An 11^{th} embodiment is any combination of the first 10 embodiments, wherein the main body has a basis weight in the range of about 100-300 lbs. per 1,000 ft².

A 12^{th} embodiment is any combination of the first 11 embodiments, wherein the strands per inch of the net structure is in the range of about 0.1 to about 5 in the transverse direction (TD), and about 0.1 to about 5 in the machine direction (MD).

A 13^{th} embodiment is any combination of the first 12 embodiments, wherein the diamond shaped openings have a length in the range of about 10 to 25 mm and a width in the range of about 10 to 25 mm.

A 14^{th} embodiment is any combination of the first 13 embodiments, wherein the main body includes an additive for protecting the wood pole against environmental conditions.

A 15^{th} embodiment is any combination of the first 14 embodiments, wherein the additive is incorporated into the thermoplastic material, or within a layer adjacent the net structure, or within a coating over the strands of the net structure.

A 16^{th} embodiment is any combination of the first 15 embodiments, wherein the additive is an insect repellent, a bird repellant, an antifungal agent, or a fire retardant agent.

A 17^{th} embodiment is any combination of the first 16 embodiments, wherein the bird repellant is configured to repel woodpeckers.

An 18^{th} embodiment is any combination of the first 17 embodiments, wherein the additive is a color agent, a luminescent agent, a fluorescent agent, a photoluminescent agent, or a light reflective agent.

A 19^{th} embodiment is any combination of the first 18 embodiments, further including an adhesive layer.

A 20^{th} embodiment is any combination of the first 19 embodiments, wherein the wood pole is a wood utility pole.

A 21^{st} embodiment is any combination of the first 20 embodiments, wherein the utility grid is an electrical or telephone grid.

According to a third aspect, in a 1^{st} embodiment, a method for protecting or bolstering a wood pole is provided. The method comprises the steps of selecting a wood pole for processing, providing a surface cover for the wood pole and placing the surface cover over a length of the wood pole that is exposed to environmental conditions.

A 2^{nd} embodiment is the 1^{st} embodiment of the method, wherein the main body has a cylindrical shape with a first, open end and a second, open end, and the step of placing comprises sliding the main body over the wood pole.

A 3^{rd} embodiment is any combination of the first 2 embodiments, wherein the step of placing comprises wrapping the main body around the length of the wood pole.

A 4^{th} embodiment is any combination of the first 3 embodiments, wherein the shaped openings comprise diamond shaped openings.

A 5^{th} embodiment is any combination of the first 4 embodiments, wherein the thermoplastic comprises a polyolefin.

A 6^{th} embodiment is any combination of the first 5 embodiments, wherein the polyolefin comprises a polypropylene, polylactic acid, polyethylene, a polybutylene adipate terephthalate, or a blend thereof.

A 7^{th} embodiment is any combination of the first 6 embodiments, wherein the net structure comprises a monofilament and extruded, non-woven material.

An 8^{th} embodiment is any combination of the first 7 embodiments, wherein the thermoplastic material is partially or fully biodegradable.

A 9^{th} embodiment is any combination of the first 8 embodiments, wherein the surface cover is placed over the wood pole prior to a preservation treatment of the wood pole.

A 10^{th} embodiment is any combination of the first 9 embodiments, wherein the surface cover is placed over the wood pole after a preservation treatment of the wood pole.

An 11^{th} embodiment is any combination of the first 10 embodiments, further including the step of applying a preservation treatment to the surface cover and the wood pole.

A 12^{th} embodiment is any combination of the first 11 embodiments, wherein the main body includes an additive for protecting the wood pole against environmental conditions.

A 13^{th} embodiment is any combination of the first 12 embodiments, wherein the additive is incorporated into the thermoplastic material, or within a layer adjacent the net structure, or within a coating over the strands of the net structure.

A 14^{th} embodiment is any combination of the first 13 embodiments, wherein the additive is an insect repellent, a bird repellant, an antifungal agent, or a fire retardant agent.

A 16^{th} embodiment is any combination of the first 15 embodiments, wherein the bird repellant is configured to repel woodpeckers.

A 17^{th} embodiment is any combination of the first 16 embodiments, wherein the additive is a color agent, a luminescent agent, a fluorescent agent, a photoluminescent agent, or a light reflective agent.

An 18^{th} embodiment is any combination of the first 17 embodiments, wherein the surface cover further includes an adhesive layer and liner, and further including the step of removing the liner and applying the surface cover onto the wood pole.

A 19^{th} embodiment is any combination of the first 18 embodiments, further including the step of installing the wood pole and surface cover in an electrical or telephone grid.

What is claimed is:

1. A surface cover for a wood pole, comprising:
a main body having a net structure formed of a plurality of intersecting strands and shaped openings between the intersecting strands, the main body being formed from a thermoplastic material.

2. The surface cover of claim 1, wherein the main body has a cylindrical shape with a first, open end and a second, open end, the main body being configured to slip over the wood pole.

3. The surface cover of claim 1, wherein the main body is configured to wrap around a length of the wood pole.

4. The surface cover of claim 1, wherein the shaped openings comprise diamond shaped openings.

5. The surface cover of claim 1, wherein the thermoplastic comprises a polyolefin.

6. The surface cover of claim 5, wherein the polyolefin comprises a polypropylene, polylactic acid, polyethylene, a polybutylene adipate terephthalate, or a blend thereof.

7. The surface cover of claim 1, wherein the net structure comprises a monofilament and extruded, non-woven material.

8. The surface cover of claim 1, wherein the thermoplastic material is partially or fully biodegradable.

9. The surface cover of claim 1, wherein the net structure has a thickness in the range of about 0.050 to about 0.300 inches.

10. The surface cover of claim 1, wherein the net structure has a knot count in the range of about 1 to about 50 in the transverse direction.

11. The surface cover of claim 1, wherein the main body has a basis weight in the range of about 100-300 lbs. per 1,000 ft².

12. The surface cover of claim 1, wherein the strands per inch of the net structure is in the range of about 0.1 to about 5 in the transverse direction (TD), and about 0.1 to about 5 in the machine direction (MD).

13. The surface cover of claim 1, wherein the diamond shaped openings have a length in the range of about 10 to 25 mm and a width in the range of about 10 to 25 mm.

14. The surface cover of claim 1, wherein the main body includes an additive for protecting the wood pole against environmental conditions.

15. The surface cover of claim 1, wherein the additive is incorporated into the thermoplastic material, or within a layer adjacent the net structure, or within a coating over the strands of the net structure.

16. The surface cover of claim 14, wherein the additive is an insect repellent, a bird repellant, an antifungal agent, or a fire retardant agent.

17. The surface cover of claim 16, wherein the bird repellant is configured to repel woodpeckers.

18. The surface cover of claim 14, wherein the additive is a color agent, a luminescent agent, a fluorescent agent, a photoluminescent agent, or a light reflective agent.

19. The surface cover of claim 1, further including an adhesive layer.

20. The surface cover of claim 1, wherein the wood pole is a wood utility pole.

21. The surface cover of claim 20, wherein the utility pole is configured for an electrical or telephone grid.

22. A utility grid comprising:
a network of connected wood poles; and
at least one surface cover for at least one of the connected wood poles;
wherein the at least one surface cover comprises a thermoplastic net structure.

23. The utility grid of claim 22, wherein the thermoplastic net structure comprises a main body formed of a plurality of intersecting strands and shaped openings between the intersecting strands.

24. A method for protecting or bolstering a wood pole, comprising:
selecting a wood pole for processing;
providing a surface cover for the wood pole; and
placing the surface cover over a length of the wood pole that is exposed to environmental conditions;
wherein the surface cover comprises a thermoplastic net structure.

25. The method of claim 24, wherein the thermoplastic net structure comprises a main body having a cylindrical shape with a first, open end and a second, open end, and the step of placing comprises sliding the main body over the wood pole.

26. The method of claim 24, wherein the thermoplastic net structure comprises a main body, and the step of placing comprises wrapping the main body around the length of the wood pole.
